(19) United States
(12) Patent Application Publication
(10) Pub. No.: US 2002/0177037 A1
(43) Pub. Date: Nov. 28, 2002

(54) Method for producing a separator/electrode assembly for electrochemical elements

(75) Inventors: Fatima Birke-Salam, Ellwangen (DE); Alfons Joas, Tannhausen (DE); Peter Birke, Ellwangen (DE); Heinrich Stelzig, Rosenberg (DE); Konrad Holl, Aalen-Dewangen (DE); Dejan Ilic, Ellwangen (DE)

Correspondence Address: SCHNADER HARRISON SEGAL & LEWIS, LLP, 1600 MARKET STREET, SUITE 3600, PHILADELPHIA, PA, 19103

(73) Assignee: Microbatterie GmbH, HANNOVER (DE)

(21) Appl. No.: 10/152,954

(22) Filed: May 21, 2002

(30) Foreign Application Priority Data
May 25, 2001 (DE) 101 25 619.1

(51) Int. Cl. H01M 4/58; B05D 5/12

(52) U.S. Cl. 429/162; 429/231.95; 427/58; 427/126.3

(57) ABSTRACT

A method for producing a separator/electrode assembly for electrochemical elements which contain at least one lithium-intercalating electrode finely dispersing insoluble active materials in a polymer matrix to form a paste; directly applying the paste to a porous separator material or to a layer composed of solid ion conductors; and drying the paste.

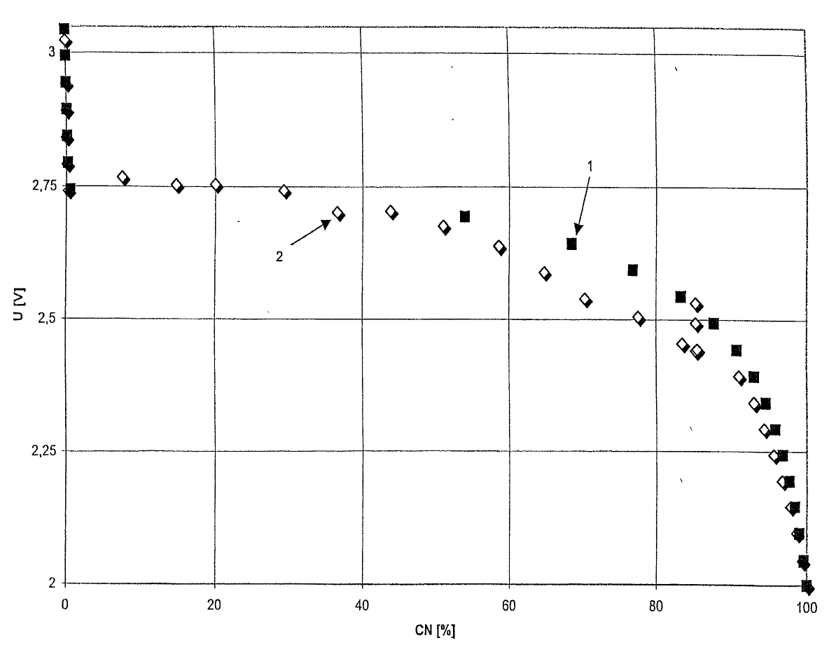

### FIELD OF THE INVENTION

This invention relates to a method for producing a separator/electrode assembly for electrochemical elements which contain at least one lithium-intercalating electrode in whose polymer matrix electrochemically active materials which are insoluble in the polymer are finely dispersed. The invention also relates to an electrochemical element having a separator/electrode assembly produced using the method.

### BACKGROUND

Widely differing methods are known for producing thin film cells with electrodes which have lithium-intercalating materials.

By way of example, WO 00/57504 discloses a thin film cell in which the positive electrode is produced from a paste mixture composed, for example, of MnO₂, carbon and electrolyte, with the paste being pasted into a frame. A separator is then placed on the frame, and pressed onto the pasty electrode at relatively high temperatures. Methods such as these have the disadvantage that the pasty substance of the positive electrode material already contains electrolyte solution, and the rest of the processing must, therefore, be carried out as quickly as possible and in special conditions, in particular, in a dry area.

EP 954 042 A1 discloses a lithium-ion rechargeable battery in which the positive and negative sheet electrodes are connected to a separator by means of an adhesion-promoting resin layer. The adhesion-promoting layers may, in particular, also result in an undesirable insulation effect between the electrode and separator and, hence, in increased internal resistance. Furthermore, layers such as these can result in undesirable substances entering the cell.

EP 1056 142 discloses a lithium-ion cell in which a gel electrolyte is arranged between the positive and negative electrode sheets. The gel is composed in particular of polyvinylidene fluoride or copolymers of polyvinylidene fluoride. The production of such cells is complex since it is necessary to process the electrodes and the gel electrolyte in a dry area. Furthermore, an electrolyte such as this often does not result in sufficient conductivity.

WO/0069010 discloses a lithium-ion cell in which a polyolefin separator is used as a separator between the positive and negative electrodes and is coated with the same binder polymer as that used in the electrodes. This procedure is complex since the separator must first be coated using wet chemical means and then still needs to be laminated afterwards.

DE 19 916 041 A1 discloses a method in which a paste mixture containing graphite, followed by a separator strip consisting of a polymer mixture and SiO₂ in paste form, are applied onto a mechanically robust carrier sheet, for example, a copper sheet, and are processed to form a sheet. Relatively thick separator layers are required to avoid contacts from being formed through the gel-like separator strip with the active substance, thus increasing the internal resistance of the cell and reducing the energy density.

Adhesion between the electrodes and separator, as well as between the electrodes and the output conductor electrodes, is a central point for the functionality of electrochemical elements. Contact can be lost electrochemically or by mechanical loss of contact due to the electrodes swelling in the electrolyte and due to gassing as a consequence of decomposition. Laminated cells are advantageous in this case, since no spontaneous loss of contact can occur, for example, due to gassing, and the form factor means that a greater energy density can be achieved. Furthermore, by virtue of its production process, a laminate is also generally more resistant to swelling.

A laminate such as this is normally based on a sheet produced by a wet chemical means in which a considerable amount, generally more than 70 percent by weight of active material, is suspended in a dissolved binder polymer and extruded by means of wipers to form a sheet. The suspension may also contain softener and agent to improve conductivity. The cell assembly is produced by lamination of the electrode sheets onto sheet-like output conductor electrodes, and the assembly produced in this way is connected to the separator in a further lamination step. The lamination temperature is normally 110° C. to 140° C. and is carried out in a strip laminator.

However, the active electrode materials cannot all be poured using a wet chemical method to form a sheet which can then also still be laminated while hot. Some sheets cannot be processed in this way, depending upon the recipe used to produce them. One way of nevertheless achieving the lamination capability is to add softeners. In the case of PVDF and HFP polymers, dibutyl phthalate is used as a softener, and this must be extracted after the lamination process.

In particular, electrode materials based on manganese, for example, manganese dioxide or spinel such as LiMn₂O₄, which are of major interest for use in lithium cells due to their low costs, environmental friendliness and good capacitance values, can be processed only with difficulty using the methods mentioned above.

It would accordingly be highly advantageous to provide a method for producing a separator/electrode assembly of the type mentioned initially, which can be carried out easily and in which, in particular, processing can be carried out in any desired atmosphere and with a wide range of electrode materials.

### SUMMARY OF THE INVENTION

This invention relates to a method for producing a separator/electrode assembly for electrochemical elements which contain at least one lithium-intercalating electrode including finely dispersing insoluble active materials in a polymer matrix to form a paste, directly applying the paste to a porous separator material or to a layer composed of solid ion conductors, and drying the paste.

### BRIEF DESCRIPTION OF THE DRAWING

The drawing is a graph of voltage (U) as a function of normalized capacitance (CN) as a percentage for a flat cell of the invention (curve 1) and a conventional flat cell (curve 2).

### DETAILED DESCRIPTION

The wetting capability and the effective surface area (BET surface area) of both the active material of the electrode and the substrate are important. If, for example, the BET surface area of the active material is such that the binding polymer accumulates in depressions due to the surface character of the material, then fundamental difficulties result in binding to a smooth binding base. Effects such as these occur, in particular, when, for example, MnO₂ or the spinel LiMn₂O₄ is used, in particular, with fluorized binder polymers.

According to the invention, this problem is solved in that the carrier onto which the active material is poured likewise has pores. Polyolefin separators which are known per se have this characteristic. It is advantageous that there is no need for any intermediate base sheet, composed of polyester, for example, during production and no prior treatment of the separator with layers that are compatible with the binder polymer of the electrode is required before the lamination process. It is, thus, possible to assemble material combinations which it was not previously possible to join together to form layers without special measures.

Polyvinylidene fluoride and hexafluoropropylene may be used as polymers that are suitable for the separator/electrode assembly according to the invention. N-methyl 1-2 pyrimidinone or acetone may be used, for example, as the solvent. The porous separator material is composed, in particular, of polyolefins or of polypropylene, polyethylene, or can be produced from a number of layers of different ones of these materials.

Metallic lithium or graphitized carbon with modifications may be used as the material for the negative electrode, while the positive electrode contains a manganese compound or, for example, electrolytic manganese dioxide as the lithium-intercalating material.

The paste mixtures for negative electrode sheets contain between about 55 and about 95 percent by weight, preferably about 65 to about 85 percent by weight, of carbon material. The paste mixture for positive electrodes contains about 65 to about 98 percent by weight, preferably about 65 to about 95 percent by weight, of the positive electrode material. Paste mixtures according to the invention contain about 50 to about 75 percent by weight, preferably about 55 to about 65 percent by weight, of solvent. The PVDF/HFP ratio for positive electrode sheets is between a maximum of about 99.5 and a minimum of about 0.5, preferably between a maximum of about 80 and a minimum of about 20. The ratio of the molecular weights between PDVF/HFP is between about 3.2 and about 2.8, preferably between about 2.3 and about 2.5.

For negative electrode sheets, the PVDF/HFP ratio is between about 99.5 and about 0.5, preferably between about 85 and about 15. The ratio of the molecular weights is between about 3.2 and about 2.8, preferably between about 2.3 and about 2.5.

The substance is produced such that the viscosity of the initial paste is set to about 1 to about 10 Pascals, preferably about 3 to about 6 Pascals.

In order to produce electrochemical elements, the separator/electrode assembly or electrode/separator/electrode assembly, which has been produced in accordance with the method according to the invention, is laminated onto at least one output conductor electrode or electrode, and the stack is then impregnated with a liquid organic electrolyte.

### EXAMPLE

A pasty substance was produced by thoroughly mixing 77 percent by weight of manganese dioxide (electrolytic MnO₂) which is thermally active at 360° C., 6 percent by weight of graphite (KS 6, Timcal), 2 percent by weight of conductive soot (Super P, Sedema), 7 percent by weight of polyvinylidene fluoride/hexafluoropropylene (Kynar Flex 2801, Elf Atochem) and 8 percent by weight of propylene carbonate (Merck) in acetone, and wiping the resulting substance onto a polyolefin separator (polypropylene, Celgard 2500), vaporizing the solvent, drying the resulting strip in a vacuum (110° C., 48 hours), impregnating it with an organic lithium electrolyte, stamping out the separator/electrode assembly pieces to a size of 1.6×2.3 cm², and inserting them into a copper sheet housing, onto whose top face lithium that had already been pressed, and whose cup face was provided with a graphite-based conductivity improver, and by ultrasound-welding the cup and cover with an insulation layer where copper meets copper.

The drawing shows the voltage U as a function of the normalized capacitance CN as a percentage for a flat cell (curve 1, black-filled squares) produced according to the example and, in comparison, the capacitance of a button cell produced using an industrial standard production method (pressing in the cathode tablet and the separator), which is based on the same electrochemistry and cathode layer thickness as the flat cell (curve 2, white, diamonds on a black background). It can be seen from the curves that the power which can be drawn turns out to be considerably better for the flat cell over this voltage range. The current density was 0.2 y mA/cm².

What is claimed is:

1. A method for producing a separator/electrode assembly for electrochemical elements which contain at least one lithium-intercalating electrode comprising:
finely dispersing insoluble active materials in a polymer matrix to form a paste;
directly applying the paste to a porous separator or to a layer composed of solid ion conductors; and
drying the paste.

2. The method as claimed in claim 1, wherein the polymer matrix is polyvinylidene fluoride (PVDF) and hexafluoropropylene (HFP).

3. The method as claimed in claim 1, wherein the paste further comprises N-methyl 1-2 pyrimidinone or acetone solvent.

4. The method as claimed in claim 1, wherein the porous separator is a polyolefin.

5. The method as claimed in claim 1, wherein the paste further comprises electrolytic manganese dioxide as a positive lithium-intercalating material.

6. The method as claimed in claim 1, wherein the paste further comprises metallic lithium as a negative active material.

7. The method as claimed in claim 1, wherein the paste further comprises graphitized carbon as an electrochemically active material for a negative electrode sheet.

8. The method as claimed in claim 1, wherein the paste for a negative electrode sheet contains between about 55 and about 95% by weight, based on the weight of the paste, of carbon material.

9. The method as claimed in claim 1, wherein the paste for a negative electrode sheet contains between about 65 and about 85% by weight, based on the weight of the paste, of carbon material.

10. The method as claimed in claim 1, wherein the paste for a positive electrode sheet contains between about 65 and about 98% by weight, based on the weight of the paste.

11. The method as claimed in claim 1, wherein the paste for a positive electrode sheet contains between about 75 and about 95% by weight, based on the weight of the paste.

12. The method as claimed in claim 1, wherein the paste contains about 50 to about 75% by weight, based on the weight of the paste, of solvent.

13. The method as claimed in claim 2, wherein the PVDF/HFP ratio for a positive electrode sheet is between about 99.5 and about 0.5, and the ratio of the molecular weights between PVDF/HFP is between about 3.2 and about 2.8.

14. The method as claimed in claim 2, wherein the PVDF/HFP ratio for a positive electrode sheet is between about 80 and about 20, and the ratio of the molecular weights between PVDF/HFP is between about 2.3 and about 2.5.

15. The method as claimed in claim 2, wherein the PVDF/HFP ratio for a negative electrode sheet is between about 99.5 and about 0.5, and the ratio of the molecular weights between PVDF/HFP is between about 3.2 and about 2.8.

16. The method as claimed in claim 2, wherein the PVDF/HFP ratio for a negative electrode sheet is between about 85 and about 15, and the ratio of the molecular weights between PVDF/HFP is between about 2.3 and about 2.5.

17. The method as claimed in claim 1, wherein the viscosity of the paste before drying is about 1 to about 10 Pascals.

18. The method as claimed in claim 1, wherein the viscosity of the paste before drying is about 3 to about 6 Pascals.

19. An electrochemical element having at least one electrode/separator assembly, produced using a method as claimed in claim 1.

20. The electrochemical element as claimed in claim 19, further comprising:
laminating a resulting separator/electrode assembly or electrode/separator/electrode assembly onto at least one output conductor electrode or electrode to form a stack; and
impregnating the stack with a liquid organic electrolyte.
